(19) United States
(12) Patent Application Publication
(10) Pub. No.: US 2026/0141166 A1
(43) Pub. Date: May 21, 2026

(54) Generating and Using Hierarchical Semantic Document Representations for LLM Tasks

(71) Applicant: Primepoint Labs Inc., Dover, DE (US)

(72) Inventors: Lubomir Bourdev, Mountain View, CA (US); Hamid Palo, Brooklyn, NY (US); Nathan Fuller, Portland, OR (US); Georgie Botev, San Francisco, CA (US)

(21) Appl. No.: 18/955,655

(22) Filed: Nov. 21, 2024

(51) Int. Cl. G06F 40/137; G06F 16/332; G06F 16/338; G06F 40/30

(52) U.S. Cl. CPC G06F 40/137; G06F 16/332; G06F 16/338; G06F 40/30

(57) ABSTRACT

In one embodiment, a method includes accessing a document that includes text. The method further includes determining, from the document, a hierarchical input that includes, for each segment of the document (1) a segment identifier that uniquely identifies that respective segment of the document and (2) corresponding text of that segment identified by the segment identifier. The method further includes determining, based the hierarchical input, a hierarchical semantic representation of the document comprising (1) an index that uniquely identifies a location in the document (2) a section ID uniquely identifying a portion of the document and (3) a title comprising a summary of the portion of the document.

### TECHNICAL FIELD

This application generally relates to generating hierarchical semantic document representations for LLM tasks.

### BACKGROUND

A large-language model (LLM) is a computer-implemented artificial-intelligence (AI) model that can perform natural-language processing tasks such as natural-language generation. For instance, an LLM can receive a natural-language input, such as a plain-text written input or a natural-language verbal input, and return a natural-language response. For example, natural-language input may be in the form of a question, or query, and the natural-language output may be an answer to the query. LLMs use artificial neural networks (NNs), including NNs that include an encoder and/or a decoder, the latter of which are typically used for generative natural-language tasks.

### BRIEF DESCRIPTION OF THE DRAWINGS

FIG. 1 illustrates an example method for creating a semantically meaningful document representation for an LLM.

FIG. 2 illustrates an example that includes a segment of a document and the corresponding hierarchical input created from that segment.

FIG. 3 illustrates an example of a hierarchical semantic representation generated from the example hierarchical input of FIG. 2.

FIG. 4 illustrates an example computing system.

### DESCRIPTION OF EXAMPLE EMBODIMENTS

A document can include a collection of text and other content, such as pictures, graphs, etc. A document typically has some semantic organization, in that concepts and topics tend to be logically organized within the document, such as similar concepts being located near each other, rather than being randomly interspersed throughout the document. For example, a document describing the game of football may include 4 paragraphs describing scoring and 10 paragraphs describing penalties. The paragraphs describing scoring are likely to be relatively near each other, and likewise the paragraphs describing penalties are likely to be near each other, while paragraphs on scoring are less likely to be interspersed with paragraphs on penalties or to be scattered throughout the document. As another example, a document describing a story, such as a novel, typically includes paragraphs next to each other that are narratively related to each other, and breaks in this organizational structure tend to be indicated through formatting or textual indications, such as page breaks, chapter indications, etc.

Technical documents in particular tend to contain a semantically organized and hierarchical structure. For example, a technical document may be divided into chapters, sections, and subsections, and these portions may be sequentially identified using, e.g., a defined set of alphanumeric strings. For example, chapters may be numbered 1-n, where n is the number of chapters in the document, and sections in each chapter may be identified by c.s, where c is the chapter number or letter and s is the subsection number or letter. A document may be organized into a hierarchical structure according to this nomenclature, for example because each chapter, section, and subsection tend to be organized logically by subject matter. For instance, a document describing carpentry techniques would tend to include descriptions of step making near each other, and descriptions of, e.g., chair making is unlikely to be interspersed within the description of making steps. In addition, descriptions of, e.g., making a rocking chair is likely to be a subset of the descriptions of chair making, and such descriptions are unlikely to be scattered throughout the carpentry document or to be interspersed with descriptions of making other kinds of chairs, such as stools.

To a computer, however, a document appears as a sequence of its constituent content, such as its alphanumeric strings. For instance, a PDF includes elements such as text and graphics, each of which has a location in the PDF and which can be organized as a set of bounding boxes, each containing at least one element, and those bounding boxes do not necessarily follow the semantic meaning of the document. For instance, semantically related paragraphs may be part of separate bound boxes, and a single bounding box may include semantically distinct concepts (e.g., may include paragraphs that are sequential but are part of separate chapters or document sections).

A user who wishes to obtain some information from a document or from a set of documents traditionally had to read the document or manually search the document for the desired content. A word or phrase search using a computer can be used to look for specific strings in the document, but this approach does not leverage the semantic meaning of the document, nor does it leverage the document's organizational structure. LLMs may be used to generate natural-language output on input including a corpus of documents; however, in order to perform natural-language processing on the document, such as answering a query about the document, an LLM-based technique needs a semantic, computational representation of the document. For instance, a set of text may be encoded as a vector, such that semantically similar texts (as determined by the particular encoding approach employed) are relatively nearer each other in the vector space. However, the choice of which text to include in a block of text sent to an encoder can dramatically affect the encoding results. For instance, sending each word one-by-one to an encoder will result in encodings that fail to capture the semantic meaning in the sentences and paragraphs formed by those constituent words. Likewise, sending a large block of text (e.g., 10s of pages of a document) will result in an encoding that fails to elucidate the semantic meaning of constituent paragraphs within those pages.

Retrieval-augmented generation (RAG) approaches to natural-language generation by an LLM involve optimizing the response of an LLM to a particular document or set of documents, rather than having the LLM principally base its response on its (often tremendously) large training dataset. In general, all the text of a particular document or set of documents may be presented along with the natural-language task (e.g., query) to be answered. However, LLMs have finite memory, and therefore this approach does not work for relatively large documents or sets of documents, nor does it work for tasks that attempt to determine the most relevant portion(s) of a document for performing a natural-language task. Therefore, the typical RAG approach involves dividing the document (or set of documents) into portions, and then performing a relevancy search on the portions, for example by using vector encodings for each portion and a vector encoding for the task, e.g., a query, and comparing the vector similarity between the portions and the query, with the most similar portion(s) being loaded into the LLM memory. The LLM's response is then based on these loaded portions. The typical RAG approach divides a document based on size metrics (e.g., each portion is 50 lines of text, or 500 lines, etc.), but as described above, this approach dismantles the semantic organization of the document and ultimately obscures and conflates the meaning of document portions. As a result, the LLM performs its task (e.g., answers a query) based on an inaccurate representation of the document, i.e., based on a representation of the document that is based on.

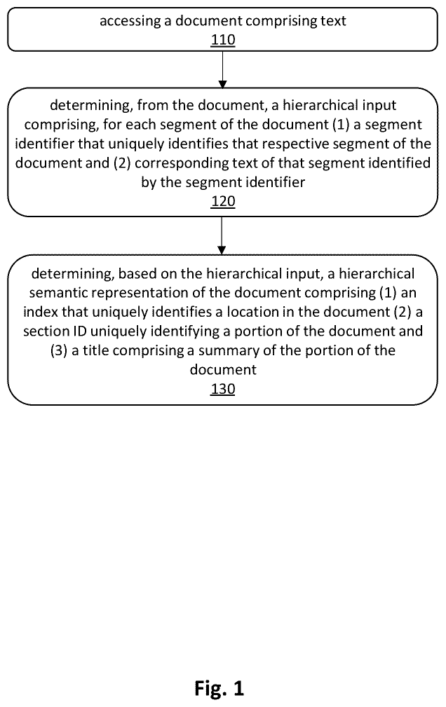

In contrast, the techniques described herein build a semantically meaningful document representation for an LLM so that meaningfully coherent, consistent sections of the document are intelligently loaded into the LLM's memory, improving LLM performance on natural-language generation tasks that are based on a particular document or set of documents. FIG. 1 illustrates an example method for creating a semantically meaningful document representation for an LLM. Step 110 of the example method of FIG. 1 includes accessing a document comprising text. Step 110 can include receiving the document at a computing device or retrieving the document, e.g., from a memory store of a computing device. As described herein, the document may be a set of documents upon which a natural-language task (e.g., a response to a query) is to be performed.

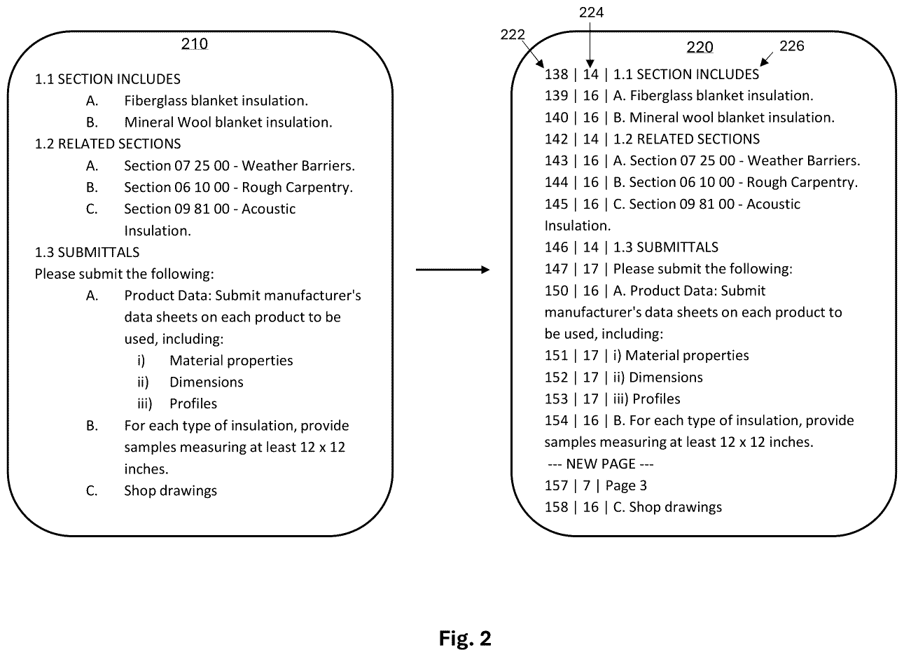

Step 120 of the example method of FIG. 1 includes determining, from the document, a hierarchical input comprising, for each segment of the document (1) a segment identifier that uniquely identifies that respective segment of the document and (2) corresponding text of that segment identified by the segment identifier. FIG. 2 illustrates an example that includes a segment 210 of a document and the corresponding hierarchical input 220 created from that segment. Hierarchical input 220 includes a number of segment identifiers 222 (e.g., “138”), a number of formatting identifiers 224, and the corresponding text 226 (e.g., “1.1 SECTION INCLUDES”) of the text segment identified by each segment identifier 222. In particular embodiments, such as in the example of FIG. 2, a segment identifier may be a line identifier, such that it uniquely identifies each line of text in the document, and the corresponding text may then be text on the line identified by it's particular line identifier. However, this disclosure contemplates that other segments (e.g., sentences, etc.) may be used. In particular embodiments, hierarchical input 220 may be an LLM input that is provided along with a corresponding prompt to a parsing LLM, as described more fully below.

As illustrated in the example of FIG. 2, particular embodiments may include a formatting identifier that identifies formatting in the segment of the document corresponding to a particular segment identifier. For instance, formatting identifier 224 in the example of FIG. 2 is an indent identifier that identifies an ident level of the corresponding text. Other formatting identifiers may be used in the addition or the alternative, such as a case identifier, emphasis (e.g., bolding) identifier, a font-type or font-size identifier, etc. As explained herein, in particular embodiments formatting may be identified in hierarchical input 220 by retaining any formatting in the corresponding text, e.g., bolded and capitalized text may be preserved as such in hierarchical input 220. Likewise, in particular embodiments indentation may be preserved and reflected in the corresponding text of hierarchical input 220, rather than being identified by a separate formatting identifier 224. While the indents identified by formatting identifier 224 in the example of FIG. 2 are represented numerically, which may be an efficient approach because it reduces the number of tokens input to an LLM, other approaches may be used (e.g., the corresponding number of space characters in the indent may be used). The hierarchical input 220 may be generated from text 210 by an extractor (e.g., a PDF extractor for a PDF document) or by an LLM, which may be different from the first LLM described below.

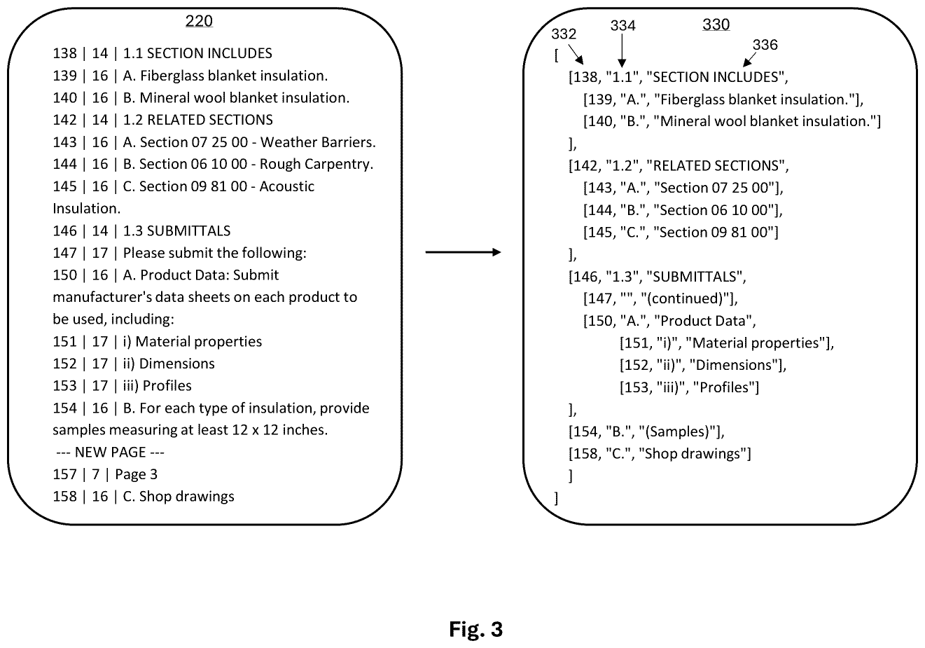

Step 130 of the example method of FIG. 1 includes determining, based on the hierarchical input, a hierarchical semantic representation of the document comprising (1) an index that uniquely identifies a location in the document (2) a section ID uniquely identifying a portion of the document that starts at the index and (3) a title comprising a summary of the portion of the document. FIG. 3 illustrates an example of a hierarchical semantic representation 330 generated from hierarchical input 220. FIG. 3 further illustrates examples of index 332, section ID 324, and title 336.

In the example of FIG. 3, index 332 corresponds to the corresponding line identifier in the hierarchical input 220. However, as described herein, in the example of FIGS. 2 and 3, the line identifier of hierarchical input 220 literally refers to the identified line in the document, while the index in hierarchical semantic representation 330 represents not just a particular line, but also the indices at corresponding lower levels in the hierarchy, which represents hierarchical information about the document. For example, the index “144” of hierarchical semantic representation 330 in the example of FIG. 3 refers to only line 144, while the index “146” of hierarchical semantic representation 330 in the example of FIG. 3 refers to lines 146-158, as indices are hierarchically beneath indices 146 by virtue of being part of what is identified as section 1.3.

As illustrated in FIG. 3, a section ID may be taken directly from the hierarchical input text, where available. However, as illustrated in FIG. 3, certain entries in the hierarchical semantic representation may have a section ID that does not come directly from the text. For example, the section ID corresponding to index 147 is blank (“ ”), indicating that this entry does not have a semantically meaningful, distinct section ID but rather is a continuation of section 1.3, and/or is a transition between section 1.3 and subsection 1.3.A.

As illustrated in FIG. 3, titles in hierarchical semantic representation 330 may be a portion of the text in hierarchical input 220. However, in particular embodiments, a title may not exactly correspond to text in the hierarchical input. For instance, using an example in which a parsing LLM generates the hierarchy, the parsing LLM generates a descriptive summary title for each index, and therefore the generated text may not correspond to any specific text in the LLM input. For example, the title corresponding to index 147 is “(continued)” and the title corresponding to index 154 is “(Samples)”. As illustrated in these examples, when the parsing LLM generates a title that is not taken directly from the text of the LLM input, then the parsing LLM may add an identifier (e.g., a pair of parentheses) to indicate this.

As described herein, the full textual content of each document portion is not part of the semantic representation, for example as generated by the parsing LLM. Instead, this full text is stored separately and is used for specific natural-language tasks, such as answering queries on a set of documents for which a hierarchical semantic representation has been generated.

In particular embodiments, step 130 may skip a table of contents section of the document. In other words, the hierarchical semantic representation is created by determining the hierarchical content of the document itself, rather than relying on, or being influenced by, the purported hierarchy and content expressed in a table of contents. For instance, a table of contents can be inaccurate, in that sections of a document may be mislabeled as to contents or location, or both. As another example, a table of contents is a fixed description of the document and may be created at a high level of detail, which fails to elucidate the semantic meaning and hierarchy of sections of the documents itself. As a result, particular embodiments of the techniques described herein intentionally identify and remove the table of contents from the process of creating a hierarchical semantic representation of a document.

To identify the table of contents in a document, particular embodiments may use heuristic rules or an LLM, or a combination of those techniques. An LLM used to identify the table of contents may be a parsing LLM or may be a different LLM. For example, an LLM may be given the initial portion of a document, e.g., using the LLM input format described above and illustrated as hierarchical input 220 in FIG. 2. The LLM may be provided a prompt that instructs the LLM to identify the table of contents from the document, and possibly other information as well, such as the title of the document. The prompt may include domain-specific information; e.g., for a construction document, the prompt may explain that a document contains a title part, a table of contents part that contains a list of CSI divisions, and a body part. The prompt may explain the format of hierarchical input 220, e.g., that “the document is a PDF that is parsed into lines that will be provided to you in the following format <ID>|<INDENT><TEXT>\n where ID is a consecutive ID of the line, INDENT is the amount of indentation of the line, which could be helpful in parsing, and TEXT is the line text.” The prompt may provide examples of input and corresponding expected output for identifying the table of contents and related information, such as the document title and the start and end of the table of contents and the start of the body section of the document. For example, an expected input may be identified in a prompt for a particular document as:
0|18|Jan. 10, 2020
1|22|GENERAL HOSPITAL BUILDING
2|30|Building Specification Document
3|30|11 Main St, Mountain View, CA 94041
4|77|1
--- NEW PAGE ---
6|5|Table of Contents
7|11|DIVISION 01 - General Requirements
8|14|Section 01 11 00 Description of Work
9|41|Section 01 11 16
10|22|Work by Owner
11|11|DIVISION 32 - EXTERIOR IMPROVEMENTS
12|14|Section 32 12 16 Asphalt Paving
13|77|2
--- NEW PAGE ---
18|9|DIVISION 01
19|12|Section 011100
20|12|Description of Work
21|14|PART 1 - General
22|12|1.01 Related Sections
   The expected output may be identified for this input as:
{
   “title”: “Building Specification Document”,
   “table_of_contents_start”: 3,
   “body_start”: 18
}

After generating a hierarchical input, particular embodiments may use the hierarchical input to identify coherent sections of the document, and then may parse each section (as in step 130 of the example method of FIG. 1) to determine the hierarchical semantic representation for that section. For instance, the limited memory of a parsing LLM may be strained by large documents, and first dividing the document into sections enables each section to be loaded into memory of the parsing LLM.

Identifying semantically coherent sections in a document may be performed by heuristic rules or by an LLM, or by a combination thereof. The sectioning LLM may be the same as, or different than, the parsing LLM or the table-of-contents identifying LLM described above. If a sectioning LLM is used, then the LLM input and a corresponding sectioning prompt may be provided to the sectioning LLM. For example, a sectioning LLM may be provided with the hierarchical input 220 in the example of FIG. 2, and a prompt may explain that the expected output is:
{
   “section_title”: “Blanket Insulation”,
   “section_CSI”: “07 21 16”,
   “part1_start”: 137,
   “part1_sections”: {“138”: “1.1”, “142”: “1.2”, “146”: “1.4” },
   “part2_start”: 154,
   “part2_sections”: {“155”: “2.1” },
   “part3_start”: 158,
   “part3_sections”: {“159”: “3.1” }
}

While hierarchical input 220 represents just a portion of the document, the hierarchical input in practice may include multiple sections, and the expected output of the sectioning LLM may then include a ““next_section_start”:{value}” field, where {value}represents the index of the start of the next section. Based on the provided hierarchical input and the prompt, the sectioning LLM identifies coherent sections of the document, and these sections may then be provided to a parsing LLM to perform the hierarchical semantic representation for that section. In particular embodiments a prompt may include heuristic rules. For example, a prompt may state that “section IDs should be consecutive, i.e. 1.3 is followed by 1.4 and then 1.5. They usually have the same indentation. While the main sections are often numbered using paired numbers like 1.1, 1.2, 1.3, . . . they could also be identified with letters like “A”, “B”.”

If a document is sectioned, then step 130 may include providing the parsing LLM an LLM input that corresponds to an identified section. In other words, the sectioning is used to identify sections of hierarchical input to provide to the parsing LLM.

A prompt provided to the parsing LLM may include instructions, such as heuristic rules, for parsing LLM input, and may include one or more examples of hierarchical input and corresponding hierarchical semantic representation for that input. The prompt may include specific instructions related to the format or contents of the hierarchical semantic representation. For example, a prompt may instruct the parsing LLM to parse each section into a list containing three or more elements: “1. int: The line ID containing the section ID and title 2. str: The section ID 3. str: The section title. If there is no title, use the section contents to create a suitable short 1-2 word title and mark it in parentheses indicating the title is synthesized. If the section has contents, the next elements will list the containing nested sections.”

A prompt may include examples of content, such as headers, footers, and page numbers, that should be discarded by the parsing LLM. For example, a prompt may include an example of LLM input as follows:
22|32|City of Phoenix
--- NEW PAGE ---
18|7|7/11
   and may identify the correct response as:
[ ]
   thereby indicating that the content should be skipped. Other embodiments of a prompt may include examples of hierarchical input that includes some incorrect input, e.g., splitting one lines into two lines or presenting lines in the wrong order, along with examples of corrected hierarchical semantic representation for such input. Embodiments of a prompt provided to a parsing LLM may include heuristic rules, e.g., explanations that indices and/or section IDs should be sequential and increasing.

Particular embodiments may verify a generated hierarchical semantic representation, for example as output by a parsing LLM (and/or of the preceding LLMs, such as the table-of-contents identifying LLM), by using another LLM that is provided a prompt and/or using heuristic rules. For instance, the output of the parsing LLM should provide indices and section IDs that are unique and sequential, and the output may be checked against these constraints. In particular embodiments, sections identified by a parsing LLM may be represented as a tree structure, and the output validation may include adjusting the tree structure if particular rules (e.g., the first node must have a starting ID (e.g., 1, A, etc.); subsequent nodes must increase in order; nodes at the same level of the hierarchy must include the same representation (e.g., “1, 2, 3” not “1, A, 3”), etc.) are not met.

In particular embodiments, the hierarchical semantic representation, for example as output by a parsing LLM, may be stored in a datastore in a structured form, e.g., as a knowledge graph. The datastore may include multiple documents, and may be structured hierarchically. For instance, when using a knowledge graph, a root node may correspond to all documents, each document may correspond to a node at one lower layer in the graph, and each document node may contain several subnodes reflecting the hierarchical semantic representation output by the parsing LLM. Subnodes may, for example, correspond to sections and subsections in document, to tables, to figures or other images, etc. In particular embodiments, an input document (e.g., a document accessed in step 110 of the example method of FIG. 1) may include multiple, distinct documents (e.g., an input PDF may include multiple documents as one PDF), and the hierarchical semantic representation of each document would then be obtained, and each document stored as a distinct node in the knowledge graph.

While particular embodiments may use an LLM to generate a hierarchical semantic representation of a document, for instance by using aspects of the example parsing LLMs described above, in other embodiments heuristic rules or a combination or heuristic rules and a parsing LLM may be used to generate the hierarchical semantic representation of the document (e.g., a parsing LLM may be used if heuristic rules provide poor output). For example, heuristic rules may identify rules for section ID numbering (for example, “4.3” follows “4.2,” and “4.3.a” must be inside “4.3”) and for indentation that are then used to derive the hierarchical semantic representation of the document. x

Once a hierarchical semantic representation of a document or a set of documents is obtained, then these representations can subsequently be used to improve the performance of natural language tasks by an LLM. For instance, a user may submit a query to an LLM regarding a set of documents. Particular embodiments pass the query and the hierarchical structure to a relevancy LLM, which identifies which section(s) of which document(s) are most relevant to the query. This is referred as a “Top Down” approach. The LLM may also receive a prompt that identifies example queries, hierarchical semantic representations, and corresponding output identifying the relevant sections for responding to the query. However, in particular embodiments, the relevancy LLM does not actually answer the query; instead, it identifies which portions of the hierarchical semantic representation are relevant to answering the query. In particular embodiments, multiple relevancy LLMs may be used, e.g., a first relevancy LLM may identify which higher-level portions (e.g., chapters) in the hierarchical semantic representation are responsive to the query, while a second relevancy LLM may identify which lower-level portions (e.g., sections within the chapters identified by the first relevancy LLM) in the hierarchical semantic representation are responsive to the query, and so on, until the desired level of granularity in the hierarchy is obtained.

To answer a query, particular embodiments use a query-answering LLM. In particular embodiments, the query and the document(s) section(s) identified by the relevancy LLM are provided to the query-answering LLM to answer the query. In particular embodiments, the relevancy LLM and the query-answering LLM may be the same LLM, or may be different LLMs. In particular embodiments, one LLM may be used in an agentic approach. For example, the query and hierarchical structure may be provided to the LLM, and the LLM may be essentially asked “do you want to answer the query or request more information?” The LLM may request subsections, and after drilling down into the hierarchical representation, the LLM may then eventually request the text of certain subsections, and then it may answer the query.

In particular embodiments, a vector embedding is created to represent the content at each section (and its subsections) by projecting the content to a point in N-dimensional space using a standard vector embedding method (for example, provided by OpenAI or other vendors). The query is also embedded in the same space, and the sections corresponding to the K closest points to the query point are the relevant portions of the document to be provided to a query answering LLM′. This approach for selecting relevant information to pass to the question-answering LLM is referred to as a “Bottom Up” approach.

In particular embodiments, a combination of approaches that may include Top Down, Bottom Up and other, are used for selecting relevant sections to pass to the query-answering LLM

In particular embodiments, a prompt is provided to a query-answering LLM along with the query and the relevant document portions. The prompt may provide instructions, along with examples, of queries and appropriate corresponding answers.

In particular embodiments, a query-answering LLM may be provided with the hierarchical semantic representation of the relevant sections, along with the content itself of those sections. The query-answering LLM may be required to validate its answer by providing citations, using the hierarchical semantic representation, for its answer. For instance, the query-answering LLM may be required to provide the index (e.g., line number) of the document content that the query-answering LLM specifically used to generate its answer. For instance, an example hierarchical semantic representation of a portion of a document may be:
SECTION 32 14 00 - Unit Paving
PART 1 - GENERAL
[
   [201, “5.0 Submittals”],
   [202, “5.1 Product Data:”,
      [203, “5.1.1 Manufacturer's data sheets for each product.”],
      [204, “5.1.2 Composition, color, and finish of pavers.”],
      [205, “5.1.3 Physical and mechanical properties including size, weight, compressive strength, and absorption.”]
   ],
   [206, “5.2 Samples for initial selection purposes.”],
   [207, “5.3 Shop Drawings detailing:”,
      [208, “5.3.1 Material locations.”],
      [209, “5.3.2 Paving patterns, grades, joints, and edges.”]
   ]
]
   An example query may be “What physical properties must be included in the pavers submissions?” and a cited answer may be “Pavers submissions must include composition, color and finish of the pavers [204], as well as their size, weight, compressive strength and absorption [205]”

Citation using the hierarchical semantic representation generated for the document by the parsing LLM forces the query-answering LLM to specifically identify support for its answer. In addition, because the indices can be very granular (e.g., at the line level), the query-answering LLM is forced to be very specific in its responses. A user can then quickly review the response to determine the accuracy of the provided answer; for example, in particular embodiments a query response may be provided to a user with an interactive link on the citation, which the user can interact with (e.g., tap or click) to pull up the cited portion of the document.

Citations can also be used as a check on LLM hallucinations in its responses. The hierarchical semantic representation process described herein helps ensure that the query-answering LLM will not hallucinate, because (1) documents are identified by semantically coherent sections (e.g., semantically distinct sections of the document are identified as such, rather than being lumped together, as in the fixed-size RAG approach described above) and (2) the hierarchical semantic representation is granular and ensures that the query-answering LLM cites a specific portion of the document to support its answer. As a result, the techniques described herein reduce or eliminate hallucinations by the query-answering LLM. However, in case the query-answering LLM hallucinations, particular embodiments may include an additional verification check on the query-answering LLM's output. For example, a validation LLM may be used to validate the output, for example by providing the output answer and the cited sections to the validation LLM and asking whether each statement in the answer can be determined from the cited document sections (e.g., only the cited lines, noting here that an index may also refer to the subsections below it). If not, then the flow is returned to the query-answering LLM, which is asked to modify its answer. If yes, then the validation LLM confirms that the query-answering LLM has not hallucinated, and the answer may be provided to the querying user.

As discussed above, the techniques described herein create a hierarchical semantic representation of a document (created, for example, by an LLM, heuristic rules, or a combination thereof) that is based on, and that conforms to, the hierarchy and semantic content within that document, rather than being based on some predetermined metric (e.g., number of lines) or predetermined table of contents. As a result, an LLM can subsequently refer to the hierarchical semantic representation to provide improved natural-language task performance on the document (or set of documents), for example by answering a query on the document. The hierarchical semantic representation improves accuracy and reduces hallucinations, both through its accuracy in representing the hierarchy and semantically grouped portions of the document, and its granular representation that permits the task-performing LLM to specifically cite support in the document, according to the hierarchical semantic representation, for its output. In addition, the task-performing LLM is not constrained to performing its tasks based on the top n relevant portions of predetermined size; rather, the LLM can refine its output (e.g., by requesting information about deeper layers in the hierarchical semantic representation) until it can satisfactorily perform the task. In addition, the hierarchical semantic representation reduces LLM hallucination.

In particular embodiments, one or more computing devices may be used to perform the techniques described herein. For example, a first computing device (which herein includes more than one computing device) may be used to access a document and determine the hierarchical semantic representation of that document using a parsing LLM. The first computing device(s) may be server devices, personal computing devices, etc. A second computing device (which may include more than one computing device) may receive a query. For example, a second computing device may be a client computing device such as a smartphone, a tablet, a personal computer, etc. The second computing device may transmit the query to the first computing device, which may determine the response to the query and submit the response to the second computing device. In particular embodiments, the first and second computing device(s) may be the same computing device(s).

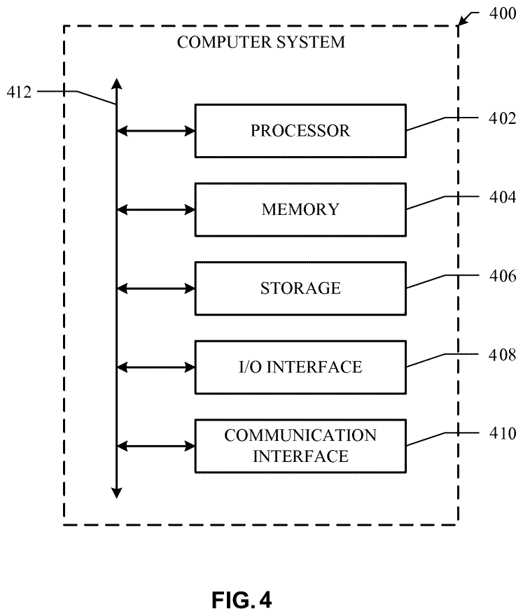

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a document comprising text;
determining, from the document, a hierarchical input comprising, for each segment of the document (1) a segment identifier that uniquely identifies that respective segment of the document and (2) corresponding text of that segment identified by the segment identifier; and
determining, based on the hierarchical input, a hierarchical semantic representation of the document comprising (1) an index that uniquely identifies a location in the document (2) a section ID uniquely identifying a portion of the document and (3) a title comprising a summary of the portion of the document.

2. The method of claim 1, wherein the hierarchical input further comprises a formatting identifier for each segment identified by the respective segment identifier.

3. The method of claim 2, wherein the formatting identifier comprises an indentation identifier.

4. The method of claim 1, further comprising storing the hierarchical semantic representation in a hierarchical data structure representing a plurality of documents.

5. The method of claim 1, further comprising:
accessing a query on a set of documents comprising the accessed document;
determining, based at least in part on the hierarchical semantic representation of each document in the set of documents, one or more document portions responsive to the query;
providing, to a query-answering LLM, the query and the one or more document portions responsive to the query; and
determining, by the query-answering LLM, a response to the query.

6. The method of claim 5, further comprising:
providing, to the query-answering LLM, the hierarchical semantic representation corresponding to the document portions responsive to the query; and
citing, in the answer and by the query-answering LLM, one or more indices identified in the hierarchical semantic representation that support the response to the query.

7. The method of claim 6, further comprising:
providing, to a validation LLM, (1) the response to the query and (2) the document portions corresponding to the cited indices; and
determining, by the validation LLM, whether the document portions corresponding to the cited indices support the response to the query.

8. The method of claim 5, further comprising:
providing the query and the hierarchical semantic representation of each document in the set of documents to a relevancy LLM; and
determining, by the relevancy LLM, section IDs in the hierarchical semantic representations that are responsive to the query.

9. The method of claim 1, wherein:
the hierarchical input is an LLM input; and
a parsing LLM determines the hierarchical semantic representation of the document based on the LLM input and an input prompt.

10. The method of claim 1, wherein:
the index comprises a line identifier; and
each line identifier refers to itself and to any line identifier at a corresponding lower hierarchical level as identified in the hierarchical semantic representation.

11. An apparatus comprising:
a first computing device comprising one or more non-transitory computer readable storage media storing instructions; and one or more processors coupled to the one or more non-transitory computer readable storage media and operable to execute the instructions to:
access a document comprising text;
determine, from the document, an LLM input comprising, for each segment of the document (1) a segment identifier that uniquely identifies that respective segment of the document and (2) corresponding text of that segment identified by the segment identifier; and
determine, by a parsing LLM and based on (1) the LLM input and (2) an input prompt, a hierarchical semantic representation of the document comprising (1) an index that uniquely identifies a location in the document (2) a section ID uniquely identifying a portion of the document and (3) a title comprising a summary of the portion of the document.

12. The apparatus of claim 11, wherein the input further comprises a formatting identifier for each segment identified by the respective segment identifier.

13. The apparatus of claim 12, wherein the formatting identifier comprises an indentation identifier.

14. The apparatus of claim 11, further comprising one or more processors coupled to the one or more non-transitory computer readable storage media and operable to execute the instructions to store the hierarchical semantic representation in a hierarchical data structure representing a plurality of documents.

15. The apparatus of claim 11, further comprising:
a second computing device comprising one or more non-transitory computer readable storage media storing instructions; and one or more processors coupled to the one or more non-transitory computer readable storage media and operable to execute the instructions to access a query on a set of documents comprising the accessed document,
wherein the first computing device further comprises one or more processors coupled to its one or more non-transitory computer readable storage media and operable to execute the instructions to:
determine, based at least in part on the hierarchical semantic representation of each document in the set of documents, one or more document portions responsive to the query;
provide, to a query-answering LLM, the query and the one or more document portions responsive to the query; and
determine, by the query-answering LLM, a response to the query.

16. The apparatus of claim 15, wherein the first computing device further comprises one or more processors coupled to its one or more non-transitory computer readable storage media and operable to execute the instructions to
provide, to the query-answering LLM, the hierarchical semantic representation corresponding to the document portions responsive to the query; and
cite, in the answer and by the query-answering LLM, one or more indices identified in the hierarchical semantic representation that support the response to the query.

17. The apparatus of claim 16, wherein the first computing device further comprises one or more processors coupled to its one or more non-transitory computer readable storage media and operable to execute the instructions to:
provide, to a validation LLM, (1) the response to the query and (2) the document portions corresponding to the cited indices; and
determine, by the validation LLM, whether the document portions corresponding to the cited indices support the response to the query.

18. The apparatus of claim 15, wherein the first computing device further comprises one or more processors coupled to its one or more non-transitory computer readable storage media and operable to execute the instructions to:
provide the query and the hierarchical semantic representation of each document in the set of documents to a relevancy LLM; and
determine, by the relevancy LLM, section IDs in the hierarchical semantic representations that are responsive to the query.

19. The apparatus of claim 18, wherein each section ID in the hierarchical semantic representation that is identified as responsive to the query as determined by the relevancy LLM is at a same level of the hierarchy in the hierarchical semantic representation.

20. A method comprising:
accessing a query on a set of documents;
determining, based at least in part on a hierarchical semantic representation of each document in the set of documents, one or more document portions responsive to the query, wherein the hierarchical semantic representation comprises (1) an index that uniquely identifies a location in the respective document (2) a section ID uniquely identifying a portion of the respective document and (3) a title comprising a summary of the portion of the respective document;
providing, to a query-answering LLM, the query and the one or more document portions responsive to the query; and
determining, by the query-answering LLM, a response to the query.

21. The method of claim 20, further comprising selecting a set of documents relevant to the query and, within each relevant document, a subset of document chapters relevant to the query to determine the one or more document portions responsive to the query.

22. The method of claim 21, further comprising determining the one or more document portions responsive to the query at least in part by an LLM presented with the query and the subset of document chapters.

23. The method of claim 21, further comprising selecting a set of relevant subsections from the subset of document chapters to determine the one or more document portions responsive to the query.

24. The method of claim 20, further comprising using a similarity in an embedding space between the query and the document subsections to determine one or more document portions responsive to the query.
